(19) United States
(12) Patent Application Publication
(10) Pub. No.: US 2007/0074700 A1
(43) Pub. Date: Apr. 5, 2007

(54) Power Tool

(75) Inventors: Heiko Rosskamp, Adelberg (DE); Michael Raffenberg, Fellbach (DE); Werner Geyer, Berglen (DE)

Correspondence Address: GUDRUN E. HUCKETT DRAUDT, LONSSTR. 59, WUPPERTAL, 42289, DE

(73) Assignee: ANDREAS STIHL AG & CO. KG, Waiblingen (DE)

(21) Appl. No.: 11/536,012

(22) Filed: Sep. 28, 2006

(30) Foreign Application Priority Data
Oct. 1, 2005 (DE) 10 2005 047 202.8

(51) Int. Cl. F02B 41/00; F01M 1/04

(52) U.S. Cl. 123/198 C; 123/196 CP

(57) ABSTRACT

A power tool has an internal combustion engine having a crankcase and a reciprocating piston. The interior of the crankcase is delimited by the reciprocating piston. A pump for conveying a fluid is provided, wherein the pump is driven by a fluctuating pressure in the crankcase. The pump conveys a foreign fluid that is different from an operating medium of the internal combustion engine. The power tool is a spraying device and the pump conveys a medium to be sprayed.

### BACKGROUND OF THE INVENTION

The invention relates to a power tool, particularly a spraying device, having an internal combustion engine provided with a crankcase. The interior of the crankcase is delimited by a reciprocating piston. The power tool has a pump for conveying a fluid, the pump being driven by the fluctuating pressure within the crankcase.

U.S. Pat. No. 4,903,655 discloses a diaphragm pump for a power tool that is driven by the fluctuating crankcase pressure of an internal combustion engine. The diaphragm pump serves for conveying the fuel to the internal combustion engine. The check valves at the vacuum side and at the pressure side of the diaphragm pump are formed within the pump diaphragm. Since the pump diaphragm is small and the check valves have only a small flow cross-section, the conveying capacity of the diaphragm pump is minimal.

In spraying devices a pump is required for conveying a medium to be sprayed. This pump is usually driven by the crankshaft. Such pumps are complex in regard to their configuration.

### SUMMARY OF THE INVENTION

It is an object of the present invention to provide a power tool of the aforementioned kind that is of a simple configuration.

In accordance with the present invention, this is achieved in that the pump conveys a foreign fluid. i.e., a fluid that is different from the operating medium of the internal combustion engine.

The pump driven by the fluctuating pressure present in the crankcase is therefore used for conveying a foreign fluid that is different from the operating medium of the internal combustion engine. By providing a driving action by means of the fluctuating pressure in the crankcase, the pump for conveying the foreign fluid can be of a simple configuration.

Preferably, the pump is a diaphragm pump. It is provided that the diaphragm pump has a valve diaphragm in which several valve elements are formed that are arranged in parallel extending flow paths. By providing the diaphragm pump with a pump diaphragm and a separate valve diaphragm, the pump diaphragm can be of a large size so that a higher conveying capacity is provided. By providing several valve elements within the valve diaphragm which valve elements are arranged in parallel to one another, a larger flow-cross-section results in sum total even though the individual valve elements have a minimal size. The minimal size of the individual valve elements results in minimal sluggishness and thus a high switching frequency. Even for internal combustion engines operating at high engine speeds in the range of 6,000 to 9,000 revolutions, a sufficiently high switching frequency results by means of this configuration.

Preferably, the valve diaphragm is provided with valve elements that are arranged at the suction (vacuum) side or intake side of the diaphragm pump as well as with valve elements that are arranged at the pressure side of the diaphragm pump. In this way, a compact configuration of the diaphragm pump results and only one valve diaphragm is required. Preferably, the number of the valve elements on the vacuum side is greater than the number of valve elements on the pressure side. It is provided that a plurality of valve elements are formed within the valve membrane so that a higher conveying volume is realized at minimal switching times of the valve elements. A simple configuration results when the valve elements are formed by U-shaped slots in the valve diaphragm.

It is provided that the pump diaphragm is loaded by a pressure spring that counteracts the underpressure (vacuum) in the crankcase. By means of the pressure spring the operating point of the pump can be shifted. When underpressure is present in the crankcase, not only the medium to be conveyed is sucked in but the pressure spring is tensioned also. The pump stroke is realized as a result of the overpressure in the crankcase and as a result of the force of the pressure spring. In this way, an excellent conveying capacity of the diaphragm pump can be obtained.

Expediently, the diaphragm pump has a first valve plate and a second valve plate wherein the first valve plate is arranged on the pump diaphragm and the valve diaphragm is arranged between the first and second valve plates. In this way, a simple and compact configuration of the diaphragm pump results. Preferably, in the first valve plate intake openings and pressure openings are provided while in the second valve plate only intake openings are provided. Accordingly, during the intake stroke, the medium flows thus through the first valve plate as well as through the second valve plate. At the pressure side, the medium flows only through the second valve plate. From here, the medium exits the diaphragm pump. In this way, the pressure loss at the pressure side is reduced.

In order to keep the pressure pulsation minimal at the intake side, the diaphragm pump is provided with a compensation chamber at the vacuum side (suction side) of the diaphragm pump. Preferably, on the side of the second valve plate that is facing away from the first valve plate a lid is arranged and between the lid and the second valve plate a compensation chamber is arranged. In this connection, the compensation chamber is in particular delimited by a compensation diaphragm that is arranged between the lid and the second valve plate. In this way, the pulsations at the vacuum side can be smoothed in a constructively simple way. By providing a diaphragm that provides a sealing function between the first and the second valve plates as well as between the second valve plate and the lid, additional seals are not needed. In this way, a minimal number of individual parts is present. Preferably, the lid has at least one compensation opening that enables pressure compensation between the compensation chamber and the environment. It is provided that the intake connector of the diaphragm pump opens into the compensation chamber and the pressure connector opens into the pressure chamber provided between the valve diaphragm and the second valve plate.

Preferably, the power tool is a spraying device and the pump that is driven by the fluctuating pressure in the crankcase serves for conveying the medium to be sprayed. The pump has a simple and compact configuration and can be sealed in a simple way. Since in the configuration of the pump as a diaphragm pump only the diaphragms and the valve plates come into contact with the medium to be sprayed, it is possible in a simple way to provide a pump that is resistant to the media to be pumped.

In order to take full advantage of the fluctuating crankcase pressure, the power tool has a second pump, especially a diaphragm pump for conveying fuel to the internal combustion engine; the second pump (fuel pump) is also driven by the fluctuating crankcase pressure. In this way, for the pump for conveying the fuel as well as for the pump for conveying a further or additional medium, e.g. a medium to be sprayed, a simple configuration is provided. Accordingly, the power tool as a whole is of a simple configuration.

### BRIEF DESCRIPTION OF THE DRAWING

FIG. 1 is a side view of a spraying device partially shown in a schematic illustration.

FIG. 2 is a longitudinal section of the spraying device of FIG. 1.

FIG. 3 is a section view of the carburetor of the spraying device.

FIG. 4 is an exploded view of the diaphragm pump of the present invention.

FIG. 5 shows the diaphragm pump of FIG. 4 during the intake stroke in a perspective illustration, partially a sectioned view.

FIG. 6 shows the diaphragm pump of FIG. 4 during the pumping stroke in a perspective illustration, partially a sectioned view.

FIG. 7 is a perspective view of a first side of the first valve plate according to the invention.

FIG. 8 is a perspective view of a second side of the first valve plate.

FIG. 9 is a plan view onto the valve diaphragm of the present invention.

FIG. 10 is a perspective view of a first side of the second valve plate of the diaphragm pump of the present invention.

FIG. 11 is a perspective view of the second side of the second valve plate of the diaphragm pump according to the invention.

### DESCRIPTION OF THE PREFERRED EMBODIMENTS

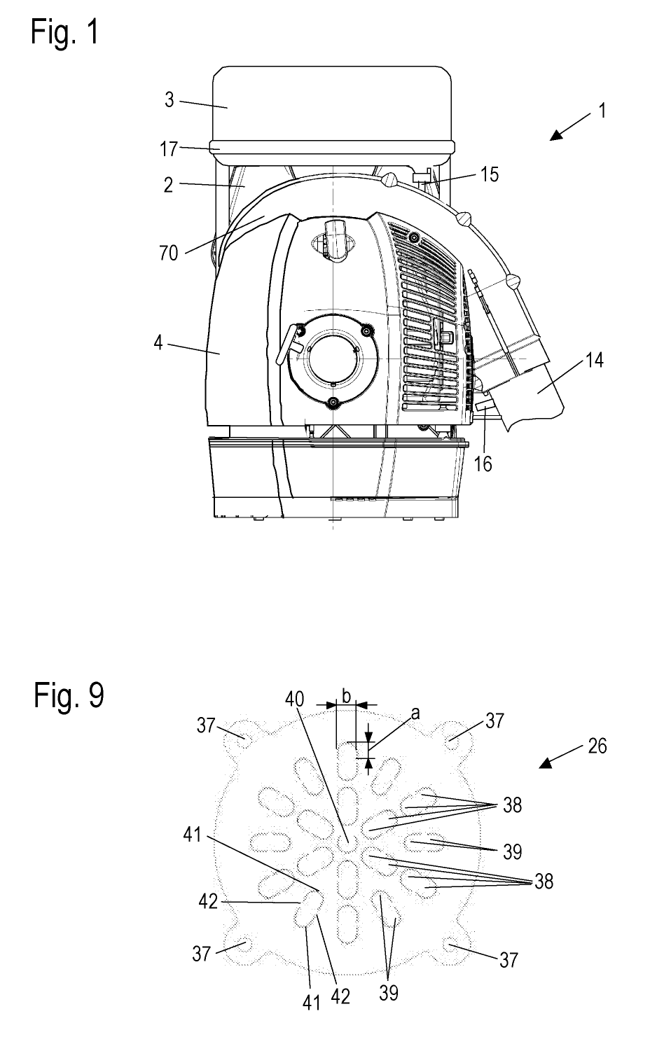

The spraying device 1 illustrated in FIG. 1 is configured as a backpack-type power tool. The spraying device 1 has a carrying frame 2 to allow the operator to carry the power tool on his back; the housing 4 is secured to the carrying frame 2. The carrying frame 2 has a frame part 17 schematically illustrated in FIG. 1 on which a tank 3 is arranged. The tank 3 serves for containing a medium to be sprayed, for example, a plant protection medium or the like, that is to be dispensed by means of the spraying device 1. The tank 3 is connected by means of a supply line 15 to a pump, not illustrated in FIG. 1. The pump conveys the medium to be sprayed out of the tank 3 through conveying line 16 to a blower pipe 14. The spraying device 1 generates an air flow in the blower pipe 14 that atomizes the medium to be sprayed and supplies it to the plants to be treated.

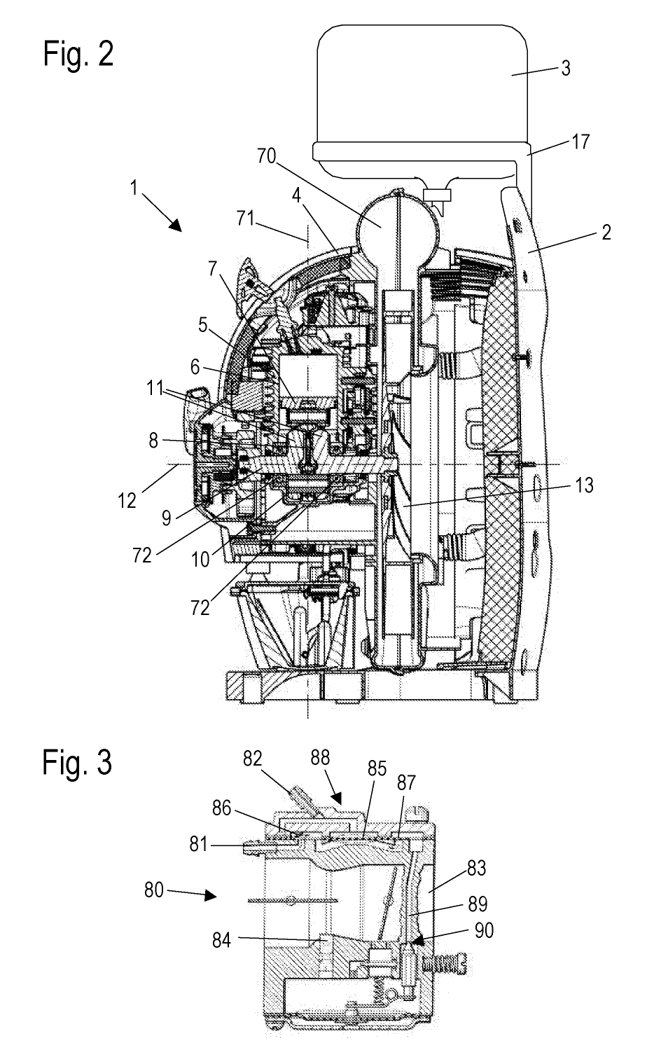

As illustrated in section in FIG. 2, the spraying device 1 has an internal combustion engine 5 arranged in the housing 4. The internal combustion engine 5 is in particular in the form of a two-stroke engine. It is also possible to provide the internal combustion engine 5 in the form of a four-stroke engine. The internal combustion engine 5 has a cylinder 6 in which a piston 7 is reciprocatingly supported. The piston 7 moves within the cylinder 6 in the direction of the longitudinal axis 71 of the cylinder 6. The piston 7 drives by means of a connecting rod 8 a crankshaft 9 supported in the crankcase 10. The crankshaft 9 is rotatingly driven about axis of rotation 12. The crankshaft 9 has crank arms 11 at both sides of the connecting rod 8. On both sides of the crank arms 11 the crankshaft 9 is supported by bearings 72 in the crankcase 10. The crankcase 10 is delimited by the piston 7 so that the pressure in the crankcase fluctuates because of the reciprocating movement of the piston 7.

The crankshaft 9 drives a fan wheel 13. The fan wheel 13 conveys, by means of blower spiral 70, air to the blower pipe 14. For conveying fuel to the internal combustion engine 5, the spraying device 1 has carburetor 80 illustrated in FIG. 3. In the carburetor 80 an intake channel 83 is provided that supplies a fuel/air mixture to the crankcase 1 0 of the internal combustion engine 5. For this purpose, a fuel opening 84 opens into the intake channel 83. The fuel is supplied by diaphragm fuel pump 88 to the fuel opening 84. The diaphragm fuel pump 88 has a connecting nipple 81 for fuel and is connected to the fuel tank of the spraying device 1. The fuel flows from the connecting nipple 81 through an inlet valve 86 into the pump chamber which is delimited by the pump diaphragm 85. An outlet valve 87 extends away from the pump chamber and is connected by means of fuel line 89 and a valve 90 to the fuel opening 84. The pump diaphragm 85 is driven by the fluctuating pressure in the crankcase 10 of the internal combustion engine 5. For this purpose, the carburetor 80 has a connecting nipple 82 by means oft which the diaphragm fuel pump 88 is connected to the interior of the crankcase 10. The intake valve 86 and the outlet valve 87 are formed within the pump diaphragm 85. In this way, the pump diaphragm 85 has only a small surface area so that the diaphragm fule pump 88 has a minimal conveying volume.

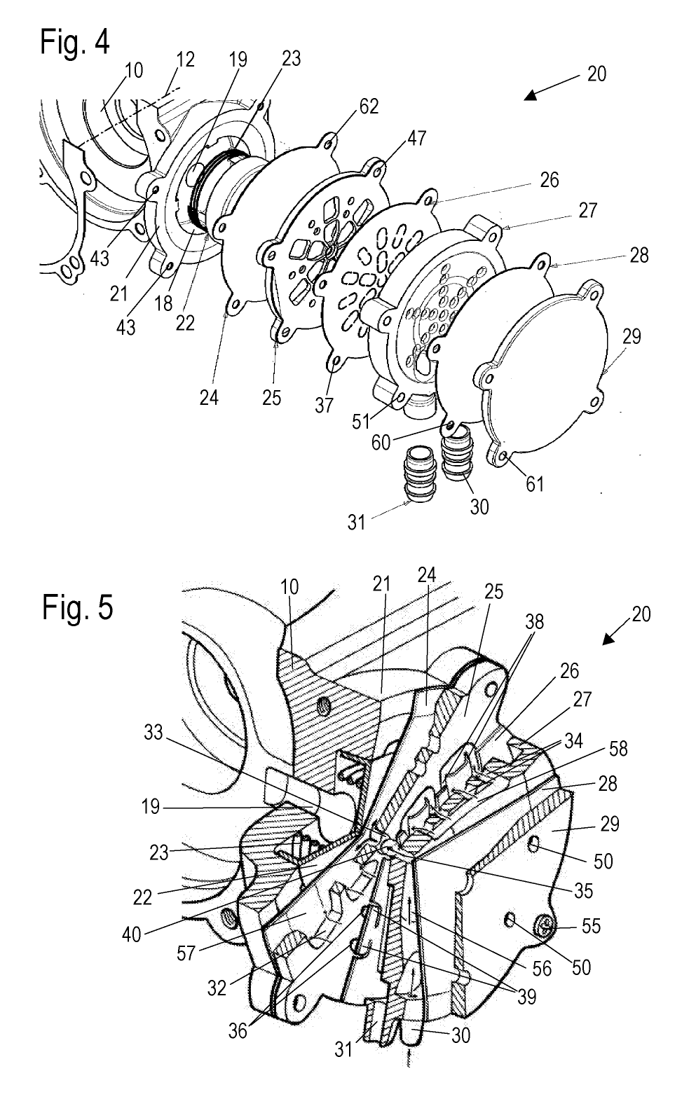

For conveying the medium to be sprayed, a diaphragm pump 20 illustrated in FIG. 4 is provided and is secured to a flange 21 of the crankcase 10. The diaphragm pump 20 is arranged on a side of the crankcase 10 that extends radially to the longitudinal axis 12 of the crankcase 10 and approximately parallel to the 20 longitudinal axis 71 of the cylinder. The flange 21 has a recess 18 in which the pump piston 22 of the diaphragm pump 20 is arranged. The pump piston 22 is supported by pressure spring 23 on the bottom of the recess 18. The recess 18 is connected by connecting opening 19 to the interior of the crankcase 10. The connecting opening 19 opens into the interior of the crankcase 10 in an area between the two crank arms 11. The flange 21 has a total of four fastening openings 43 for the diaphragm pump 20.

A pump diaphragm 24 having fastening openings 62 is arranged on the flange 21. On the side of the pump diaphragm 24 opposite the flange 21 a first valve plate 25 with fastening openings 47 is arranged. A valve diaphragm 26 with fastening openings 37, a second valve plate 27 with fastening openings 51, a compensation diaphragm 28 having fastening openings 60 as well as a lid 29 with fastening openings 61 are secured to the first valve plate 25. The flange 21, the pump diaphragm 24, the first valve plate 25, the valve diaphragm 26, the second valve plate 27, the compensation diaphragm 28, and the lid 29 have approximately the same size, are substantially circular and of a disk shape. In a stacked arrangement of these parts, the fastening openings of all these parts are aligned with one another and substantially congruent. Four fastening openings each are provided so that the diaphragm pump 20 can be assembled and simultaneously attached to the crankcase 10 with a total of four fastening means, such as screws. The diaphragm pump 20 has an intake connector 30 that opens into the area between the second valve plate 27 and the compensation diaphragm 28. A pressure connector 31 of the diaphragm pump 20 where the medium exits the diaphragm pump 20 communicates with the area between the second valve plate 27 and the valve diaphragm 26. The intake connector 30 as well as the pressure connector 31 are provided on the second valve plate 27.

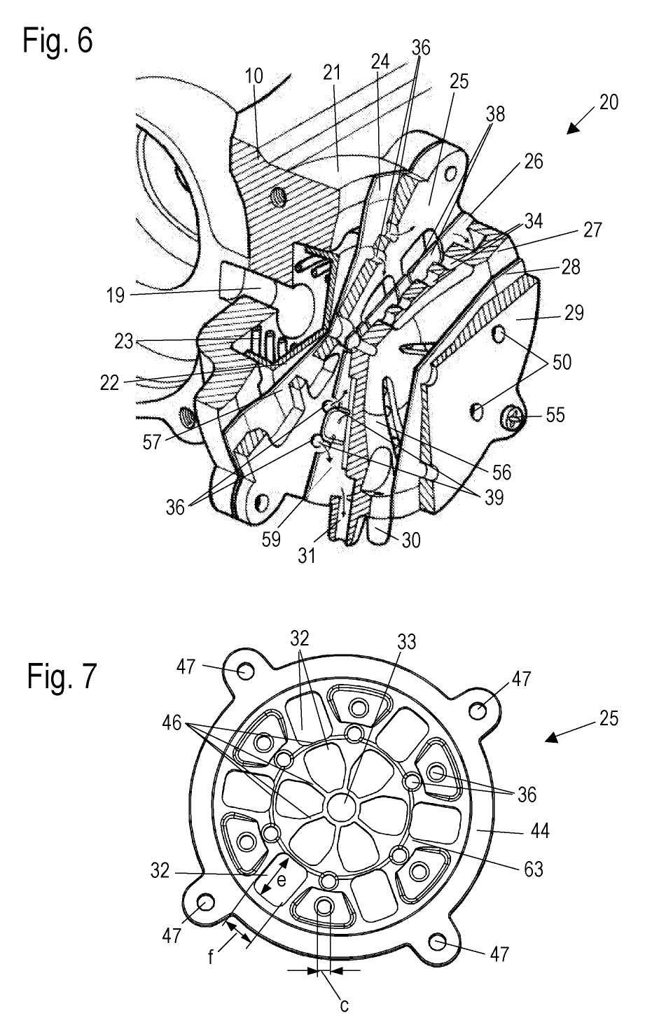

With the aid of FIGS. 5 and 6 the function of the diaphragm pump 20 will be explained in the following. FIG. 5 shows the diaphragm pump 20 during the intake stroke. During the intake stroke, the piston 22 is completely arranged within the recess 18. The pressure spring 23 is tensioned. The pump diaphragm 24 is pulled by the pump piston 22 against the flange 21 and rests against it. The pump diaphragm 24 can be secured mechanically to the pump piston 22. However, the pump diaphragm 24 can also be pulled as a result of the crankcase underpressure against the pump piston 22. Between the pump diaphragm 24 and the first valve plate 25 a pump chamber 57 is formed and the medium to be sprayed is sucked into this pump chamber 57. The medium to be sprayed passes through the intake openings 32 and a central intake opening 33 provided in the first valve plate 25. The medium to be sprayed is sucked in through the intake connector 30 into the compensation chamber 56 arranged between the second valve plate 27 and the compensation diaphragm 28. The compensation chamber 56 is connected by a plurality of intake openings 34 as well as a central intake opening 35 in the second valve plate 27 to the intake openings 32 and 33. Between the intake openings 34 and 35 and the intake openings 32, 33 there are valve elements 38 and 40 provided at the intake side; they are formed within the valve diaphragm 26. The intake openings 32, 33 in the first valve plate 25 have such a size that the valve elements 38, 40 can fold or collapse into the intake openings 32, 33. The intake openings 34, 35 in the second valve plate 27 are smaller so that the valve elements 38, 40 cannot open in the opposite direction. In order to enable a uniform distribution of the sucked-in medium to be sprayed onto the intake openings 34, 35 in the second valve plate 27, radially adjacently positioned intake openings 34 are connected to one another by a radially extending channel 58 (FIG. 5).

During the intake stroke, the compensation diaphragm 28 is pulled away from the lid 29 against the second valve plate 27. In the lid 29 compensation openings 50 are provided that enable pressure compensation between the environment and the chamber that is formed between the lid 29 and the compensation diaphragm 28. Simultaneously, medium now flows through the intake connector 30 into the compensation chamber 56. In this way, a uniform intake can be achieved so that the pressure pulsations at the intake side of the diaphragm pump 20 are reduced. The lid 29 however can also be configured without compensation openings (as shown in FIG. 4).

During the intake stroke, the pressure openings 36 provided in the first valve plate 25 are closed by valve elements 39 so that backflow of the medium to be sprayed to the pressure side of the diaphragm pump 20 is prevented.

FIG. 6 shows the pump stroke of the diaphragm pump 20. As a result of the pressure in the crankcase 10, the piston 22 and the pressure spring 23 force the pump diaphragm 24 against the first valve plate 25. The medium to be sprayed contained in the pump chamber 57 is now forced through the pressure openings 36 in the first valve plate 25 and through the valve diaphragm 26 into a pressure chamber 59 arranged between the valve diaphragm 26 and the second valve plate 27. From here, the medium to be sprayed flows through the pressure connector 31 out of the diaphragm pump 20. The medium to be sprayed flows through the valve elements 39 provided within the valve diaphragm 26 at the pressure side. The intake-side valve elements 38 are forced by the pump pressure against the second valve plate 27 and seal the intake openings 33, 34. Since the intake openings 33 and 34 in the second valve plate 27 are smaller than the valve elements 38 and the central valve element 40, the valve elements 38, 40 cannot open and the medium to be sprayed cannot be forced to flow back to the intake side.

The intake stroke of the diaphragm pump 20 is realized counter to the force of the pressure spring 23. The pump stroke is realized by means of the overpressure in the crankcase as well as by the force that is stored within the pressure spring 23. The pressure differences in the crankcase are completely utilized so that an excellent pumping efficiency results.

In FIG. 7, the side orface 44 of the first valve plate 25 is shown; this side 44 is facing the crankcase 10. The first valve plate 25 has a central intake opening 33 as well as twelve intake openings 32 that are arranged like rays extending radially outwardly away from the central intake opening 33. In this connection, two intake openings 32 are arranged in a row extending from the central intake opening 33 to the circumference of the valve plate 25. In the circumferential direction between two rows of intake openings 32 there are two pressure openings 36, respectively. The pressure openings 36 are also aligned in the radial direction. There are twelve pressure openings 36 total. The pressure openings 36 have the diameter c. The intake openings 32 have a width f measured in the circumferential direction and a length e measured in the radial direction. The width f as well as the length e are greater than the diameter c of a pressure opening 36. The intake openings 32 and the central intake opening 33 are separated from one another stays 46. The stays 46 support and stabilize the valve diaphragm 26. The intake openings 32, 33 occupy a large portion of the surface area of the first valve plate 25. The side 44 of the first valve pate 25 has a recess 63 that extends across a large portion of the surface area of the first valve plate 25; the shape of the recess 63 matches approximately the shape of the deflected pump diaphragm 24. In this way, a minimal dead space of the diaphragm pump 20 results.

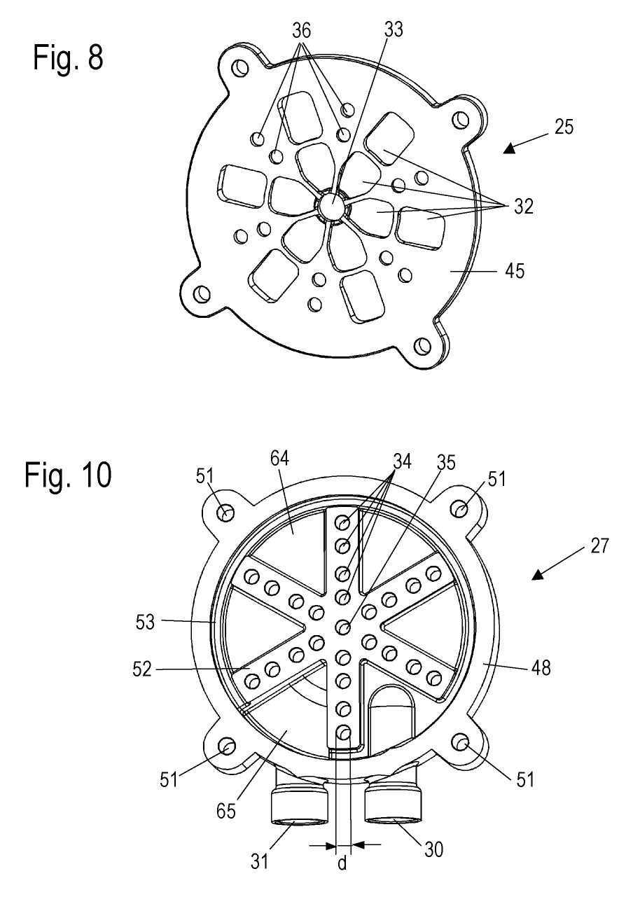

The side or face 45 of the first valve plate 25 that is facing the valve diaphragm 26 is shown in FIG. 8; it is of a plane configuration. In this way, an excellent sealing action of the valve elements is achieved.

FIG. 9 shows the valve diaphragm 26. The valve diaphragm 26 has a central valve element 40 that is smaller than the central intake opening 33 in the first valve plate 25 so that the central valve element 40 can open into the central intake opening 33. Six rows of four intake-side valve elements 38 are radially arranged like rays relative to the central valve element 40. The valve elements 38 are formed each by a U-shaped slot 41 in the valve membrane 26. Two slots 41 are arranged relative to one another such that the ends of the U are opposed to one another (FIG. 9). Between the ends of the U there are stays 42 so that the valve elements 38 are separated from one another. Two valve elements 38 facing one another are arranged in the area of one intake opening 32, respectively. Between two adjacent rows of valve elements 38 there are oppositely arranged valve elements 39; the valve elements 39 are arranged in the area of the pressure openings 36, respectively. The valve elements 38, 39 have a width b measured in the circumferential direction; the width b is greater than the diameter of the pressure openings 36 and smaller than the width f of the intake openings 32. The radially measured length a of the valve elements 38, 39 is greater than the diameter c of the pressure openings 36 and smaller than the width of the intake openings 32. In this way, the valve elements 38 can open in the intake direction and are closed in the pressure direction. Accordingly, the pressure openings 36 are closed during the intake stroke and are open during the pump stroke.

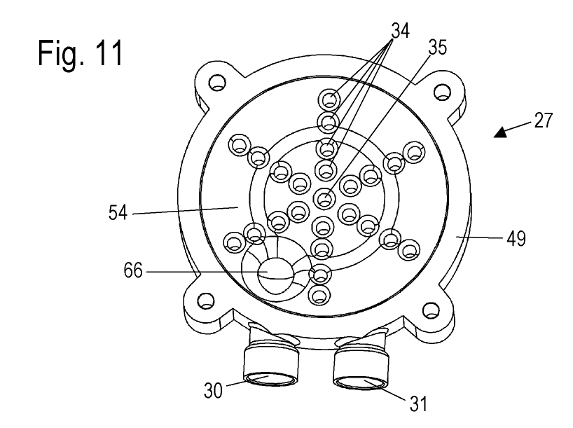

FIGS. 10 and 11 show the second valve plate 27. FIG. 10 shows the side or face 48 of the second valve plate 27 that is facing the diaphragm 26. The second valve plate 27 has a central intake opening 35 and intake openings 34 that are arranged like rays that extend radially away from the central opening 35. Four intake openings 34 are arranged in a row extending away from the central intake opening 35 toward the edge of the second valve plate 27. Six uniformly distributed rows of four intake openings 34 each are provided. Two intake openings 34 are arranged in the area of two opposed valve elements 38 and of one intake opening 32, respectively. The intake openings 34, 35 have a diameter d that is smaller than the length a and the width b of the valve elements 38. The intake openings 34, 35 are arranged on webs 52 that are plane and rest against the valve diaphragm 26 so that an excellent sealing action results. Between the webs 52 extending in a star-shaped arrangement intermediate spaces 64 are formed that are connected to one another by an annular groove 53 positioned radially outwardly relative to the webs 52. The intermediate space 65 arranged in the area of the pressure connector 31 is deeper than the intermediate spaces 64 so that an excellent flow connection results.

FIG. 11 shows the side or face 49 of the second valve plate 27 facing the compensation diaphragm 28. The intake openings 34, 35 are rounded so that a minimal flow resistance results. The opening 66 into which the intake connector 30 at the side 49 of the second valve plate 27 opens is also rounded. The side 49 of the second valve plate 27 has a recess 54 across the entire surface area of the second valve plate 27; the shape of the recess 54 corresponds to that of the deflected compensation diaphragm 28.

As shown in FIG. 4, a diaphragm 24, 26, 28 is arranged between the cylinder flange 21, the valve plates 25 and 27, and the lid 29, respectively. Since the diaphragms have a sealing function, it is not necessary to provide additional seals. By means of the fastening openings, the individual parts of the diaphragm pump 20 can be secured by a total of four screws 55 (FIG. 4 and FIG. 5) on the cylinder flange 21.

The diaphragm pump 20 can be used also for conveying other media than the ones specifically disclosed.

The specification incorporates by reference the entire disclosure of German priority document 10 2005 047 202.8 having a filing date of Oct. 1, 2005.

While specific embodiments of the invention have been shown and described in detail to illustrate the inventive principles, it will be understood that the invention may be embodied otherwise without departing from such principles.

What is claimed is:

1. A power tool comprising:
an internal combustion engine having a crankcase and a reciprocating piston, wherein an interior of the crankcase is delimited by the reciprocating piston;
a pump for conveying a fluid, wherein the pump is driven by a fluctuating pressure in the crankcase;
wherein the pump conveys a foreign fluid that is different from an operating medium of the internal combustion engine.

2. The power tool according to claim 1, wherein the pump is a diaphragm pump.

3. The powertool according to claim 2, wherein the diaphragm pump has a valve diaphragm provided with valve elements that are arranged in flow paths of the foreign fluid, wherein the flow paths extend parallel to one another.

4. The power tool according to claim 3, wherein at least a first one of the valve elements is arranged on an intake side of the diaphragm pump and at least a second one of the valve elements is arranged on a pressure side of the diaphragm pump.

5. The power tool according to claim 3, wherein more of the valve elements are provided on an intake side than on a pressure side of the diaphragm pump.

6. The power tool according to claim 3, wherein a plurality of the valve elements are provided within the valve diaphragm.

7. The power tool according to claim 3, wherein the valve elements are U-shaped slots provided in the valve diaphragm.

8. The power tool according to claim 2, wherein the diaphragm pump comprises a pump diaphragm and a pressure spring that loads the pump diaphragm, wherein the pressure spring counteracts underpressure present in the crankcase.

9. The power tool according to claim 8, wherein the diaphragm pump comprises a first valve plate, a second valve plate, and a valve diaphragm, wherein the first valve plate is arranged on the pump diaphragm, and wherein the valve diaphragm is arranged between the first valve plate and the second valve plate.

10. The power tool according to claim 9, wherein the first valve plate has intake openings and pressure openings, and wherein the second valve plate has only intake openings.

11. The power tool according to claim 9, wherein the diaphragm pump has a compensation chamber at an intake side of the diaphragm pump.

12. The power tool according to claim 11, wherein the diaphragm pump further comprises a lid arranged on a side of the first valve plate that is facing away from the second valve plate, wherein the compensation chamber is arranged between the lid and the second valve plate.

13. The power tool according to claim 12, wherein the compensation chamber is delimited by a compensation diaphragm that is arranged between the lid and the second valve plate.

14. The power tool according to claim 12, wherein the lid has at least one compensation opening that enables pressure compensation between the compensation chamber and an environment of the power tool.

15. The power tool according to claim 12, wherein the diaphragm pump has an intake connector that opens into the compensation chamber and further has a pressure connector that opens into a pressure chamber provided between the valve diaphragm and the second valve plate.

16. The power tool according to claim 1, wherein the power tool is a spraying device and the pump conveys a medium to be sprayed.

17. The power tool according to claim 1, further comprising a fuel pump conveying fuel to the internal combustion engine, wherein the fuel pump is driven by the fluctuating pressure in the crankcase.

18. The power tool according to claim 17, wherein the fuel pump is a diaphragm pump.
